(19) United States
(12) Patent Application Publication
(10) Pub. No.: US 2006/0227104 A1
(43) Pub. Date: Oct. 12, 2006

(54) Rotation display apparatus using two display buffers in mobile phone and method thereof

(75) Inventor: Ji-Hwa Kim, Chilgok-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/333,251

(22) Filed: Jan. 18, 2006

(30) Foreign Application Priority Data
Apr. 12, 2005 (KR) 2005-30325

(51) Int. Cl. G09G 5/00

(52) U.S. Cl. 345/156; 382/274; 382/154; 345/96

(57) ABSTRACT

Disclosed is a rotation display apparatus capable of reducing an image distortion phenomenon caused when a liquid crystal display (LCD) window is rapidly rotated and a method thereof. The rotational display method of a mobile phone for a predetermined image including N image frames, includes (1) storing a first image frame in a first display buffer, in which an odd image frame is stored, (2) storing a second image frame in a second display buffer, in which an even image frame is stored, while the stored first image frame is displayed, (3) storing a third image frame in the first display buffer while the stored second image frame is displayed, and (4) alternately outputting the odd image frame and the even image frame stored in the first display buffer and the second display buffer, respectively, by repeating steps (1), (2), and (3) until an Nth image frame is displayed.

### PRIORITY

This application claims the benefit under 35 U.S.C. §119(a) of a Korean Patent Application entitled “Rotation Display Apparatus Using Two Display Buffers in Mobile Phone and Method Thereof” filed in the Korean Intellectual Property Office on Apr. 12, 2005 and assigned Serial No. 2005-30325, the entire contents of which are incorporated herein by reference.

### BACKGROUND OF THE INVENTION

1. Field of the Invention

The present invention relates to a display apparatus capable of reducing an image distortion phenomenon caused when a liquid crystal display (LCD) window is rapidly rotated and a method thereof. More particularly, the present invention relates to a rotation display apparatus for storing and outputting images by alternately using two display buffers and a method thereof.

2. Description of the Related Art

Generally, in a procedure of displaying an image on a liquid crystal display (LCD) window, specific image frames are written in a single display buffer and then read from the single display buffer and displayed on the LCD window using a vertical synchronization (V-Sync) signal and a horizontal synchronization (H-Sync) signal.

A conventional mobile phone has, in the past, been used only for a simple communication function. More recently, additional mobile phone functions have been developed with the advent of high speed wireless data communication functions such as the General Packet Radio Service (GPRS), the Code Division Multiple Access (CDMA) Evolution Data Only (EV-DO), the CDMA Evolution Data and Voice (EV-DV), the Wideband Code Division Multiple Access (WCDMA), and the High Speed Downlink Packet Access (HSDPA). Due to the development of high speed wireless data communication, the size of a liquid crystal display window on a mobile phone for displaying mass-storage image data has been gradually enlarged. In particular, recently, a mobile phone (hereinafter, referred as a “rotation window-type mobile phone”) has been developed for allowing users to view images through a LCD window which can be rotated by 90 to 270 degrees.

However, the rotation window-type mobile phone has a problem in that an image distortion phenomenon may occur when the LCD window is rotated. The image distortion phenomenon denotes a phenomenon in which a part of an image is not displayed on the LCD window. In detail, when the LCD window is rapidly rotated into the wide-view position, a part of an image is not displayed due to a difference between a writing time and a reading time for a display buffer.

For example, when a LCD window having an image of a standing person is rotated by 90 degrees, the standing person becomes a lying person for a moment. In this case, in order to show the image of the standing person in a state in which the LCD window has been shifted into a wide-view position, the mobile phone transmits new image frames to the display buffer so that the image of the standing person can be shown even if the LCD window maintains the wide-view position. The LCD window with the wide-view position displays image frames stored in the display buffer by sequentially reading the image frames from the display buffer. However, the conventional technique having the above operation causes the image distortion phenomenon due to a difference between the rotation speed of the LCD window and an image writing speed to the display buffer and an image reading speed to the LCD window.

For example, an illustrative and specific image frame is shown in FIG.3. Although image data within an image frame 100 shown in FIG. 3 comprises certain alphanumeric characters for the purpose of description, binary data may be included in the image frame 100. If a LCD window is rotated by 90 degrees, a controller reads image data of the image frame 100 so as to write the image data in a display buffer 110 in a direction and order shown through reference numeral 102 (12345678→abcdefghijk→ABC . . . ). Then, the LCD window 120 reads the image data from the display buffer 100 so as to write the image data on the LCD window 120 in a direction and order shown through reference numeral 114 (12345678→abcdefghijk→ABC . . . ).

However, a conventional liquid crystal display (LCD) device can display image frames at a speed of at least 60 Hz. If a writing speed on the display buffer is slower than an image display speed on the LCD window, an image distortion phenomenon may occur in which a specific area of the LCD window is not displayed, as shown at 122 shown in FIG. 1.

In other words, the LCD window reads and displays one line of image data (e.g., “1234567890”) from the display buffer while the image data is written in the display buffer. Since the LCD window attempts reading of image data of “abcdefg” on the second line before the image data is written in the display buffer, the data “a” from of the second line image cannot be read, so that the image distortion phenomenon occurs as shown at 122 of FIG. 1.

In order to overcome the above problem, if a processor chip for a middle sized image is used, the image distortion phenomenon may be reduced. However, when an additional processor chip is used, manufacturing costs increase.

### SUMMARY OF THE INVENTION

Accordingly, the present invention has been made to address the above-mentioned problems, and an object of the present invention is to provide an apparatus and a method for displaying an image on a LCD window by using two display buffers in order to reduce an image distortion phenomenon caused by the conventional signal display buffer.

Another object of the present invention is to provide a method for displaying an image, in which two display buffers alternately records image data of an image frame, and a LCD window alternately reads the image data of the image frame from the display buffers.

To accomplish the above objects, a rotational display method of a mobile phone for a predetermined image including N image frames is provided. The rotational display method comprises (1) storing a first image frame in a first display buffer in which an odd image frame is stored, (2) storing a second image frame in a second display buffer, in which an even image frame is stored, while the stored first image frame is displayed, (3) storing a third image frame in the first display buffer while the stored second image frame is displayed, and (4) alternately outputting the odd image frame and the even image frame stored in the first display buffer and the second display buffer, respectively, by repeating steps (1), (2), and (3) until an N^{th} image frame is displayed.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a conventional image distortion phenomenon;

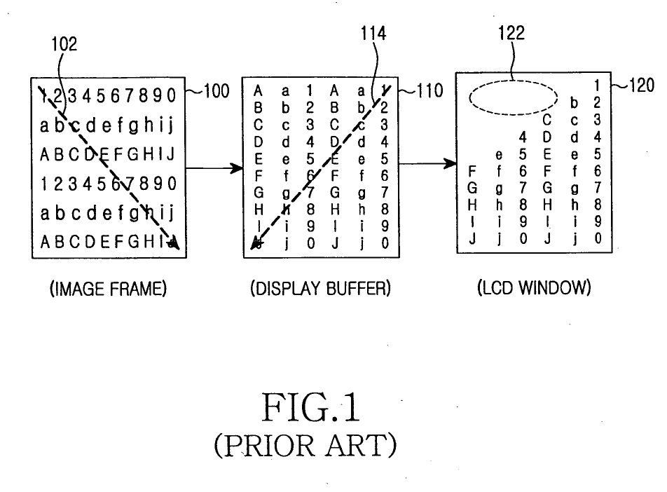

FIG. 2 is a block diagram illustrating an internal structure of a mobile phone according to an exemplary embodiment of the present invention;

FIG. 3 is a view for explaining an operation of a first display buffer and a second display buffer according to an exemplary embodiment of the present invention; and

FIG. 4 is a flowchart illustrating a procedure of sequentially displaying an image frame by using two alternating display buffers according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described in detail with reference to the accompanying drawings. In the following description of the present invention, a detailed description of known functions and configurations incorporated herein will be omitted for clarity and conciseness. In addition, the terminology are defined herein in consideration of functions performed in the present invention, and may vary according to common usage by those skilled in the art.

According to an exemplary embodiment of the present invention, a mobile phone including a camera will be described as an example. However, the present invention may be applied to a mobile phone having a television (TV) receiver, as well as a typical mobile phone having no camera or TV receiver.

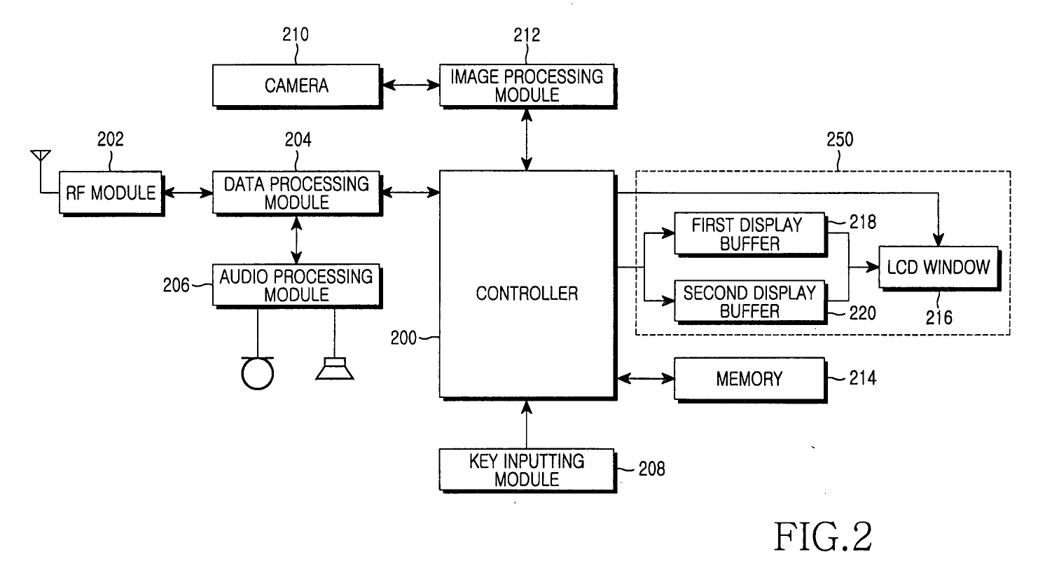

FIG. 2 is a block diagram illustrating a structure of a mobile phone according to an exemplary embodiment of the present invention. A radio frequency (RF) module 202 performs a wireless communication function of the mobile phone. The RF module 202 comprises a RF transmitter which up-converts and amplifies a frequency of a transmitted signal and a RF receiver which low-noise amplifies a received signal and down-converts a frequency of the received signal. A data processing module 204 comprises a transmitter for encoding and modulating the transmitted signal and a receiver for demodulating and decoding the received signal. That is, the data processing module 204 may comprise a MODEM, a data CODEC for processing packet data, and so on, and an audio CODEC for processing audio signals such as voices.

An audio processing module 206 reproduces an audio signal output from the audio CODEC of the data processing module 204 through a speaker or sends a transmission audio signal generated from a microphone to the audio CODEC of the data processing unit 204.

A key inputting module 208 comprises keys for inputting numeral and later information and function keys for setting a variety of functions.

A memory 214 comprises a program memory and a data memory. The program memory stores a booting program and operating system (OS) used for controlling a general operation of the mobile phone. The data memory stores a variety of data generated during the operation of the mobile phone. In addition, the data memory stores a still image formed using a single image frame and a moving picture formed using a plurality of image frames.

A camera 210 comprises a camera sensor to photograph a specific image using an optical signal and to convert the optical signal into an electrical signal. The image photographed through the camera sensor is converted into an electrical signal and transmitted to an image processing module 212.

The image processing module 212 converts the electrical signal relating to the image received from the camera 210 into image data to be expressed as image signals. The image processing module 212 converts an electrical signal output from the camera 210 into image data so as to process the image data based on a frame. In addition, the image processing module 212 outputs the image frame suitably for the characteristic and the size of a LCD window 216. In addition, the image processing module 212 including an image CODEC compresses an image displayed on the LCD window 216 or decompresses the compressed frame image into an original frame image through a preset scheme. Herein, the image CODEC may comprise a JPEG CODEC, an MPEG 4 CODEC, a Wavelet CODEC, and so on.

The controller 200 controls the operation of the mobile phone. In particular, according to an exemplary embodiment of the present invention, the controller 200 writes image frames in a first display buffer and a second display buffer, alternately reads the image frames of the first display buffer and the second display buffer onto the LCD window, and then displays the image frames on the LCD window.

The LCD window 216, which is a liquid crystal display device for displaying an image signal output from the first display buffer 218 or the second display buffer 220 according to an exemplary embodiment of the present invention, is rotatably realized.

The first display buffer 218 and the second display buffer 220 temporarily store image frames to be displayed on the LCD window 216. The first display buffer 218 and the second display buffer 220 alternately read the image frames from the memory 214 or the image processing part 212 and sequentially display the read image frames on the LCD window. Accordingly, the image frames, which are stored in the first display buffer 218 and the second display buffer 220, respectively, are sequentially read and displayed, so that the a image distortion phenomenon can be reduced.

According to an exemplary embodiment of the present invention, a function and an operation of a display apparatus 250 is provided for removing the image distortion phenomenon by using the LCD window and the first and the second display buffers.

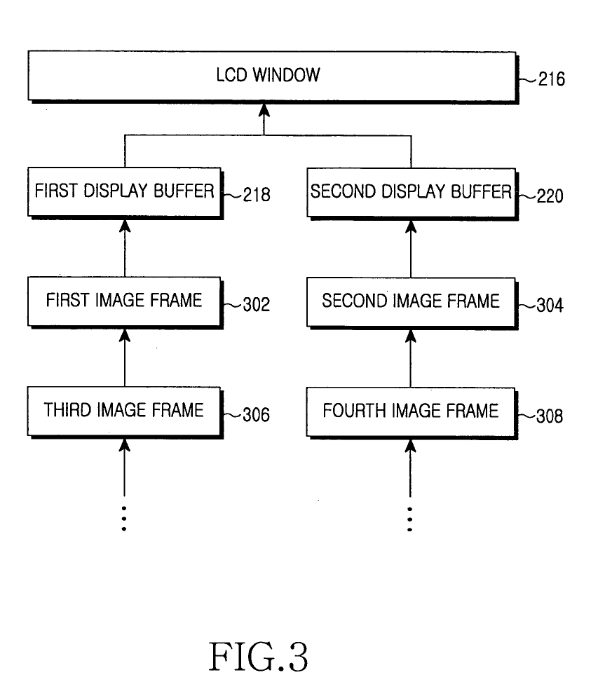

Herein, the function and the operation of the first display buffer 218 and the second display buffer 220 will be described in more detail with reference to FIG. 3. The first display buffer 216 reads and stores odd image frames from the memory or the image processing part and then outputs the stored odd image frames on the LCD window 216. The odd image frames denote the image frames positioned with an odd order among a plurality of image frames. For example, when a predetermined image comprises a first image frame, a second image frame, a third image frame, a fourth image frame, . . . , and an N^{th} image frame, the odd image frames correspond to odd image frames such as the first image frame 302, the third image frame 306, . . . , and so on.

The second display buffer 216 reads and stores even image frames from the memory or the image processing part and then outputs the stored even image frames on the LCD window 216 after the odd image frames are output. The even image frames denote the image frames positioned with an even order among a plurality of image frames. For example, when a predetermined image comprises a first image frame, a second image frame, a third image frame, a fourth image frame, . . . , and a N^{th} image frame, the even image frames correspond to image frames such as the second image frame 304, the fourth image frame 308, . . . , and so on.

Finally, the controller stores the first image frame 302 in the first display buffer 218 and then outputs the first image frame on the LCD window 216. While the first image frame 302 is displayed, the controller stores the second image frame 304 on the second display buffer 220. Then, the controller outputs the second image frame 304 having been stored in the second display buffer 220 to the LCD window after the display of the first image frame is finished. As described above, alternative output of an odd image frame and an even image frame is repeated until the last image frame is output. Herein, it is natural that an image output per frame is based on a V-Sync signal.

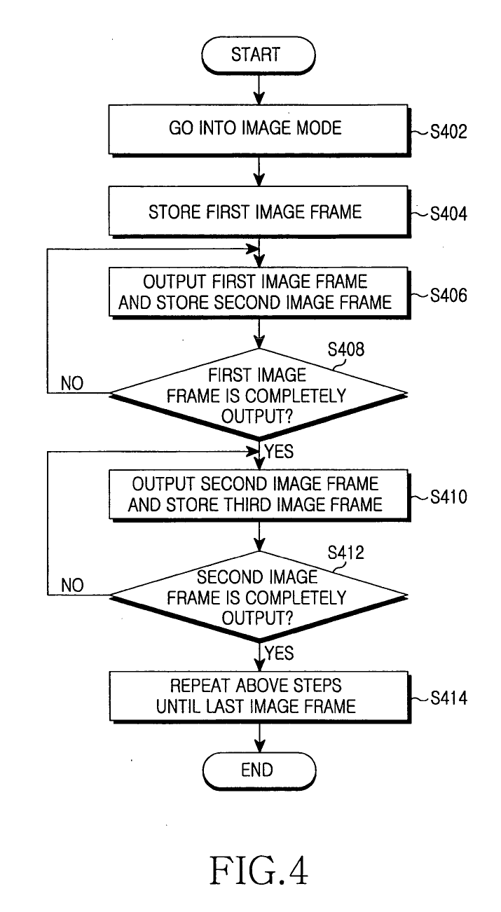

FIG. 4 is a flowchart illustrating a procedure of displaying an image frame by using two display buffers according to an exemplary embodiment of the present invention.

If a mobile phone has an image mode in which a predetermined image having a plurality of image frames is output through a LCD window in step S402, a first image frame among the plural image frames is stored in the first display buffer at step S404. After the first image frame is completely stored, the first image frame is displayed on the LCD window. A second image frame is stored in the second display buffer at step S406 while the first image frame is displayed on the LCD window. In other words, the second image frame is stored in the second display buffer while the first image frame is output.

Then, it is determined if the first image frame has been completely output at step S408. If it is determined that the first image frame has been not completely output as the determination result, the first image frame is continuously output at step S406. The determination at step S408 if the first image have been completely displayed may be achieved using a predetermined synchronization signal. In detail, if the V-Sync signal, which is generated whenever a frame is output, is generated, it may be determined that a certain frame has been completely output.

In the meantime, if it is determined that the first image frame has been completely output as the determination result for the display completion of the first image frame, the third image frame is stored in the first display buffer while the second image frame stored in the second display buffer is output at step S410. If the second image frame has been completely output at step S412, the third image frame is output.

Finally, a procedure in which an odd image frame and an even image frame are alternately stored and output in the first display buffer and the second display buffer is repeated at step S414, so that an image can be displayed without an image distortion phenomenon.

As described above, according to an exemplary embodiment of the present invention, an image is stored and output using alternately two display buffers, thereby removing an image distortion phenomenon. In particular, it is possible to remove the image distortion phenomenon occurring when a LCD window is rapidly rotated.

It is to be understood that more than two display buffers can be used, and that the image frames shored in respective ones of the buffers can be read out sequentially for displaying.

While the invention has been shown and described with reference to exemplary embodiments thereof such as a mobile phone, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A method for reducing an image distortion phenomenon in a mobile phone having a liquid crystal display (LCD) for a predetermined image including N image frames, the method comprising the steps of:
(1) storing a first image frame in a first display buffer in which an odd image frame is stored;
(2) storing a second image frame in a second display buffer, in which an even image frame is stored, while the stored first image frame is displayed;
(3) storing a third image frame in the first display buffer while the stored second image frame is displayed; and
(4) alternately outputting the odd image frame and the even image frame stored in the first display buffer and the second display buffer, respectively, by repeating steps (1), (2), and (3) until an N^{th} image frame is displayed.

2. The method as claimed in claim 1, wherein the first display buffer stores an odd image frame among a plurality of image frames.

3. The method as claimed in claim 1, wherein the second display buffer stores an even image frame among a plurality of image frames.

4. The method as claimed in claim 1, wherein the first image frame and the second image frame are displayed according to a vertical synchronization (V-Sync) signal.

5. An apparatus for displaying a predetermined image on a liquid crystal display (LCD) window of a mobile phone, the predetermined image including N number of image frames, the apparatus comprising:
a first display buffer for storing an odd image frame while an even image frame is displayed;
a second display buffer for storing the even image fame while the odd image frame is displayed;
a liquid crystal display (LCD); and
a controller programmed to generate a LCD window on the LCD by alternately displaying image frames stored in the first display buffer and the second display buffer.

6. An apparatus as claimed in claim 5, wherein the controller is programmed to display the image frames accordingly to a vertical synchronization (V-Sync) signal.

7. A method for reducing an image distortion phenomenon in a mobile phone having a liquid crystal display (LCD) for a predetermined image including N image frames, the method comprising the steps of:
storing a plurality of image frames in different ones of a plurality of display buffers; and
selectively displaying earlier arriving ones of a plurality of image frames on a LCD while later arriving ones of the image frames are being stored in respective ones of the display buffers.
